(19) United States
(12) Patent Application Publication
(10) Pub. No.: US 2008/0154778 A1
(43) Pub. Date: Jun. 26, 2008

(54) METHOD AND APPARATUS FOR DECODING RIGHT OBJECT AND METHOD AND APPARATUS FOR SHARING CONTENTS USING THE SAME

(75) Inventors: Jae-won LEE, Yongin-si (KR); Bo-gyeong Kang, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/836,227

(22) Filed: Aug. 9, 2007

(30) Foreign Application Priority Data
Dec. 22, 2006 (KR) 2006-133083

(51) Int. Cl. H04K 1/00

(52) U.S. Cl. 705/51

(57) ABSTRACT

A method and apparatus for decoding a right object and a method and apparatus for sharing contents using the same, the method of sharing contents including: receiving a Digital Rights Management (DRM) agent to interpret a right object corresponding to the contents; operating the received DRM agent to generate a coding key and a decoding key to code and decode the right object, respectively; decoding the received right object by using the decoding key and extracting a contents decoding key in order to decode the content; and decoding the contents received from a predetermined device by using the contents decoding key. Therefore, coded contents can be shared even in different DRM systems, and since DRM agent may be provided as software at the time the content is shared, the DRM agent need not be originally included by a device manufacturer, thereby reducing a development cost.

### CROSS-REFERENCE TO RELATED APPLICATION

This application claims the benefit of Korean Patent Application No. 2006-133083, filed on Dec. 22, 2006 in the Korean Intellectual Property Office, the disclosure of which is incorporated herein by reference.

### BACKGROUND OF THE INVENTION

1. Field of the Invention

Aspects of the present invention relate to a method and apparatus for decoding a right object and a method and apparatus for sharing contents using the same, and more particularly, to a method and apparatus for decoding a right object in a Digital Rights Management (DRM) system in order for a right object issued from a first DRM system to be interpreted and processed in a device employing a second DRM system, particularly when contents protected by the first DRM system are to be used in a device protected by the second DRM system, and a method and apparatus for sharing contents using the same.

2. Description of the Related Art

A Digital Rights Management (DRM) system manages contents so that only allowed users, who have permission to use the contents, use the contents. In general, the DRM system includes a contents provider, a right issuer, and a client. The contents provider provides contents and the right issuer grants, changes, or removes a right object with respect to contents for a user. The client is provided with contents from the contents provider and refers to the right specified in a corresponding right object in order to use the contents. The right object is a file in which a usage right of contents is written. A separate right object exists for each item of content.

FIG. 1 is a diagram illustrating a conventional DRM system that shares contents. Referring to FIG. 1, according to a format of contents of a first DRM system, contents coded by a right issuer 120 are downloaded to a contents storage unit 140 of a first device 130. A user of the first device 130 purchases or obtains a right object in order to play back the contents in the first device 130 and stores the right object in a right object storage unit 150. The contents and the right object are transmitted to a second device 170 by an application 155.

The second device 170 includes an application 195 that receives the contents and the right object and has enough storage space to receive the contents and the right object from the application 155 of the first device 130. When the second device 170 is connected to the first device 130 and receives the contents and the right object, the application 195 decodes the contents and the right object according to a second DRM system used in the second device 170 and stores the decoded contents and the decoded right object in a contents storage unit 180 and a right object storage unit 190, respectively. In this case, the coded contents conform to the contents format of each DRM system and the right object conforms to a rights expression language of each DRM system.

In an existing DRM system, it is assumed that the contents are only played back in a terminal in which the right object is issued. However, if there are more than one of a user's terminals controlled by the DRM system and the user wants purchased contents to be played back in two or more terminals, the user is forced to purchase additional right objects for each terminal in which the contents are to be played back. Moreover, if DRM systems employed by the terminals are not compatible with each other, transmission of the contents between the terminals is limited.

In addition, since the field of intellectual property rights protection with respect to digital contents is increasing, various kinds of DRM systems have been created due to interests between a contents provider, a service provider, and a device manufacturer. However, a method of sharing contents between each different DRM system does not currently exist, resulting in a user inconvenience.

### SUMMARY OF THE INVENTION

Aspects of the present invention provide a method and apparatus for decoding a right object in order for the right object, which conforms to a first Digital Rights Management (DRM) system, to be interpreted and used in a device employing a second DRM system, and a method and apparatus for sharing contents using the same.

According to an aspect of the present invention, there is provided a method of sharing contents from a Digital Rights Management (DRM) system, the method including: receiving a DRM agent to interpret a right object corresponding to the contents; operating the received DRM agent to generate a coding key to code the right object; receiving the contents from a predetermined device and receiving the right object; decoding the right object using the decoding key to extract a contents decoding key to decode the contents; and decoding the contents received from the predetermined device using the contents decoding key.

According to another aspect of the present invention, there is provided a method of decoding a right object corresponding to contents in a Digital Rights Management (DRM) system, the method including: generating a coding key and a decoding key to code and decode the right object, respectively; transmitting the coding key to a predetermined device; receiving the right object coded by using the coding key from the predetermined device; and decoding the received right object by using the decoding key and extracting a contents decoding key from the decoded right object to decode the corresponding contents.

According to another aspect of the present invention, there is provided a computer readable recording medium encoded with one of the methods described above and implemented by a computer.

According to another aspect of the present invention, there is provided an apparatus to receive shared contents, the apparatus including: a receiving unit to receive a Digital Rights Management (DRM) agent for interpreting a right object corresponding to the contents, to receive the contents from a predetermined device, and to receive the right object; a DRM agent operating unit to generate a decoding key to decode the right object by operating the received DRM agent, to decode the right object by using the decoding key, and to extract a contents decoding key for decoding the contents; and a contents decoding unit to decode the contents received from the predetermined device by using the contents decoding key.

According to another aspect of the present invention, there is provided an apparatus for decoding a right object corresponding to shared contents, the apparatus including: a binding information obtaining unit to generate a coding key and a decoding key to code and to decode the right object, respectively; and a right object decoding unit to decode the right object by using the decoding key when the right object coded with the coding key is received from a predetermined device, and to extract a contents decoding key from the decoded right object to decode the contents.

According to another aspect of the present invention, there is provided: a method of sharing contents with a device, the method including: transmitting a Digital Rights Management (DRM) agent to the device in order for the device to interpret a right object corresponding to the contents; receiving a coding key generated by the device operating the DRM agent; coding the right object by using the coding key; and transmitting the right object and the contents to the device.

According to another aspect of the present invention, there is provided: an apparatus for sharing contents with another device, the apparatus including: a transmission unit to transmit the contents, a right object corresponding to the contents, and a Digital Rights Management (DRM) agent to the other device in order for the device to interpret the right object; and a right object coding unit to receive the a coding key generated by the other device operating the DRM agent, and to code the right object by using the coding key.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a conventional Digital Rights Management (DRM) system that shares contents;

FIG. 2 is a diagram illustrating an overall DRM system according to an embodiment of the present invention;

FIG. 3 is a block diagram illustrating a first device of FIG. 2 for sharing contents;

FIG. 4 is a flow chart illustrating a method of sharing contents in the first device of FIG. 2 for sharing contents;

FIG. 5 is a block diagram illustrating an apparatus for sharing contents in a DRM system according to an embodiment of the present invention;

FIG. 6 is a block diagram illustrating an apparatus for decoding a right object in a DRM system according to an embodiment of the present invention;

FIG. 7 is a flow chart illustrating a method of sharing contents in a DRM system according to an embodiment of the present invention; and

FIG. 8 is a diagram of a layered structure when an apparatus for decoding a right object is provided in a device.

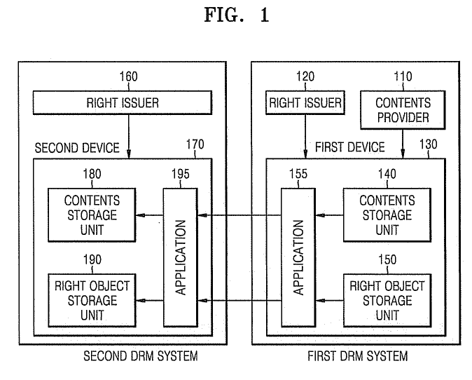

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

In a Digital Rights Management (DRM) system, contents are coded using a coding technique, information on contents and purchase conditions is inputted and stored in a right object, personal information is inputted and stored in a certificate, and each generation of the right object and the certificate is performed in a server.

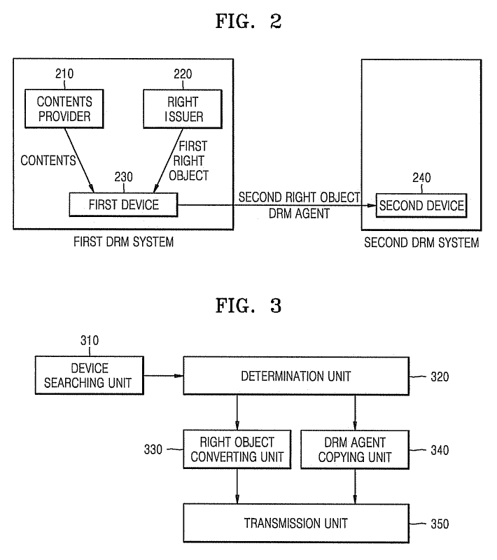

FIG. 2 is a diagram illustrating an overall DRM system according to an embodiment of the present invention. A first DRM system includes a contents provider 210, a right issuer 220, and a first device 230, and a second DRM system includes a second device 240.

The contents provider 210 provides contents to the first device 230. The right issuer 220 issues a first right object, which includes the usage rights of the provided contents, to the first device 230. The contents provider 210 and the right issuer 220 conform to procedures and methods according to rules and standards defined in a first DRM system.

The first device 230 transmits a DRM agent and a second right object to the second device 240. The DRM agent is mobile (portable) software that interprets and uses a right object. The DRM agent transmitted by the first object interprets and uses a right object that conforms to the rules and standards defined in the first DRM system. In addition, the DRM agent interprets and uses details of the right issued to a contents purchaser specified in a right object, and extracts a contents decoding key to decode the coded contents and to play back the contents. The second right object conforms to the rules and standards defined in the first DRM system in order for the first device 230 to provide a portion or all of the details of the right specified in the first right object issued from the right issuer 220 to the second device 240.

Therefore, even though the second device 240 employs the second DRM system, the second device 240 can play back the contents by interpreting the right object employing the first DRM system by using the DRM agent.

The second right object is generated by the first device 230 and issued by the right issuer 220 according to a legal procedure. It is understood that according to other aspects of the present invention, a third device authorized by the right issuer 220 can issue the second right object and/or the DRM agent.

The second right object contains details of the rights to be transferred from the first device 230 to the second device 240 and is formed according to the rules and standards of the first DRM system. Accordingly, the second right object cannot be interpreted and used in the second device 240 provided in the second DRM system that does not apply the same rules and standards as the first DRM system. Therefore, in order for the second right object to be interpreted and used in another DRM system (for example, the second DRM system), the DRM agent is transmitted to the other system. For example, referring to FIG. 2, the DRM agent is transmitted from the first device 230 to the second device 240.

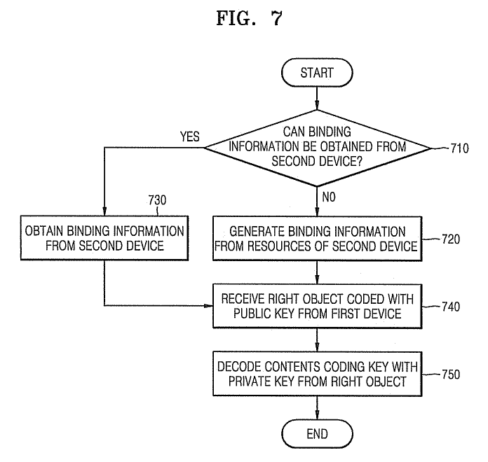

The DRM agent is mobile software and a base platform to execute the DRM agent may be commonly embodied in the first device 230 and the second device 240. A java platform is a non-limiting example of the base platform. Such a platform will be described in more detail later with reference to FIG. 7.

As the second device 240 employs the second DRM system, the second device 240 receives the second right object and the DRM agent from the first device 230. After the DRM agent is provided, installed, and/or executed in the second device 240, the second right object can be interpreted and thus a key for decoding the coded contents can be extracted.

When the key to decode the coded contents is extracted, a legal right to play back the contents is obtained. Therefore, the DRM agent is transferred to the second device 240 in order to interpret the second right object provided by the first device 230 so as to extract secret information (such as the key) for decoding the contents. In other words, the first device 230 provides the usage right with respect to the contents to the second device 240.

FIG. 3 is a block diagram illustrating the first device 230 for sharing the contents of FIG. 2. The first device 230 that shares the contents illustrated in FIG. 2 will be described with reference to FIGS. 2 and 3.

The first device 230 includes a device searching unit 310, a determination unit 320, a right object converting unit 330, a DRM agent copying unit 340, and a transmission unit 350.

The device searching unit 310 searches for a device to share contents with (for example, the second device). In this case, a user interface may be provided for a user to easily select the device.

The determination unit 320 determines whether the second device 240 can interpret the second right object that is to be transmitted. When it is determined that the second device 240 cannot interpret the second right object, the DRM agent is transmitted to the second device 240. Then, it is determined whether binding information to operate the DRM agent can be obtained in the second device 240. The binding information is used to limit the second right object that is to be used only in the second device 240 and may perform, for example, a key agreement protocol with a public key and a private key in a public-key cryptography or the right issuer 220 so as to include a commonly shared secret key. The public-key cryptography, also known as asymmetric cryptography, is a form of cryptography in which a user has a pair of cryptographic keys (a public key and a private key). The private key is kept secret, while the public key may be widely distributed. The secret key cryptography, also known as symmetric cryptography, uses a single secret key for both encryption and decryption.

Interpreting a right object includes extracting the coded information included in the right object by performing decoding. The determination performed in the determination unit 320 may include determining whether the DRM agent can receive binding information existing in the second device 240 or whether new binding information can be generated from resources of the second device 240.

If it is determined that the DRM agent can receive the binding information existing in the second device 240 or new binding information can be generated from resources of the second device 240, the determination unit 320 outputs a control signal to convert the right object to the right object converting unit 330 and a control signal to copy the DRM agent to the DRM agent copying unit 340. A platform supporting the DRM agent may exist in the second device 240 in order for the DRM agent to generate the binding information in the second device 240.

If it is determined that the second device 240 can interpret the second right object that is to be transmitted, the DRM agent does not have to be transmitted to the second device 240.

When the right object converting unit 330 receives a control signal to convert a right object from the determination unit 320, a portion or all of the details of the right specified in the first right object is converted into the second right object and is output to the transmission unit 350, wherein the second right object conforms to the first DRM system. The second right object may be bound to the second device 240 (i.e., the second right object may only be used in the second device 240). For example, a method of performing a key agreement protocol between the public key of the second device 240 or the first and second devices 230 and 240 so as to code the second right object using the commonly shared private key may be used.

When the DRM agent copying unit 340 receives a control signal to copy the DRM agent from the determination unit 320, the DRM agent copying unit 340 copies the DRM agent owned by the first device 230 and outputs it to the transmission unit 350.

The transmission unit 350 receives the second right object from the right object converting unit 330 and/or the DRM agent from the DRM agent copying unit 340 and transmits the second right object and/or the DRM agent to the second device 240.

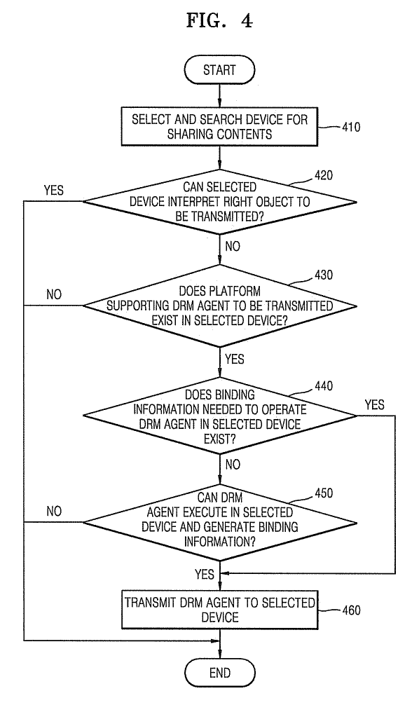

FIG. 4 is a flow chart illustrating a method of sharing contents from the first device 230 illustrated in FIG. 2. A method of sharing contents from the first device 230 will be described with reference to FIGS. 2 and 4.

In operation 410, the first device 230, which shares its own contents, searches and selects a device to which a part or all of the contents will be transmitted.

In operation 420, it is determined whether the second device 240 selected in operation 420 can interpret the right object received (or to be received) from the first device 230. For example, by performing a handshaking process between the first device 230 and the second device 240, it is determined whether the second device 240 employs the first DRM system. If the second device 240 employs the first DRM system, the first device 230 does not have to transmit the DRM agent and may transmit only the right object to the second device 240.

If the second device 240 does not employ the first DRM system, it may be determined whether the DRM agent that can interpret the right object of the first DRM system exists in the second device 240. If the DRM agent exists in the second device 240, the first device 230 does not have to transmit the DRM agent and may transmit only the right object to the second device 240. However, if the DRM agent does not exist in the second device 240 (or even if the DRM agent exists, a version thereof is too old to have sufficient function), the process may proceed to operation 430.

In operation 430, it is determined whether a platform that supports the DRM agent exists in the second device 240. If the platform does not exist in the second device 240, the DRM may not be transmitted to the second device 240.

If the platform exists in the second device 240 (operation 430), it is then determined whether binding information that is necessary to operate the DRM agent exists in the first device 230. The binding information may include identification (ID) of the second device 240 and the commonly shared secret key that is obtained after performing a key agreement protocol with the public key and the private key or the right issuer 220. If the binding information exists in the first device 230 (operation 440), the DRM agent is transmitted to the second device in operation 460.

If the binding information does not exist in the first device 230 (operation 440), it is determined whether the DRM agent can generate the binding information from the second device 240 in operation 450. Accordingly, if the DRM agent cannot generate binding information from the second device 240, the DRM agent is not transmitted to the second device 240. However, if the DRM agent can generate the binding information, the DRM agent is transmitted to the second device in operation 460. The binding information may be generated by reading existing information stored in the second device 240 or using the resources (for example, device ID) of the second device 240. While the DRM agent is transmitted from the first device 230 to the second device 240, data (except for confidential information of the first device 230) and codes of the DRM agent may be copied and then transmitted to the second device 240.

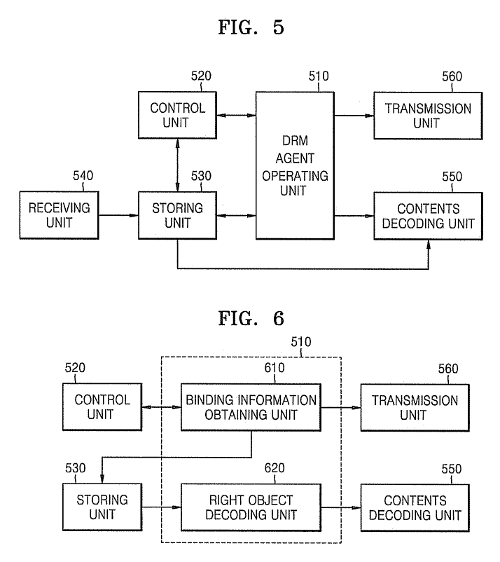

FIG. 5 is a block diagram illustrating an apparatus for sharing contents in a DRM system according to an embodiment of the present invention. The apparatus for sharing contents in the DRM system will be described with reference to FIGS. 2 through 5.

A DRM agent operating unit 510 receives the DRM agent transmitted from the first device 230 and operates the DRM agent to share the contents. Specifically, the DRM agent operating unit 510 first obtains the binding information if the binding information exists in the second device 240. However, if the binding information does not exist in the second device 240, the binding information is generated from the resources of the second device 240. The resources may include, for example, identification information of the second device 240 (such as a CPU serial ID and a device ID of the second device 240). Then, the right object, which is received from the first device 230 and coded, is stored in a storing unit 530 and interpreted using the binding information. Specifically, if the stored right object is coded by the public key in the public-key cryptography, the right object is decoded using the private key stored in the storing unit 530. If the key to decode the contents (the contents decoding key) included in the right object is re-coded, the re-coding is decoded. The contents decoding key generated by decoding is outputted to a contents decoding unit 550.

A control unit 520 sends control signals to the DRM agent operating unit 510 in order for the obtained or generated binding information to be stored in the storing unit 530 and for a portion or all of the binding information to be outputted to a transmission unit 560. The binding information outputted to the transmission unit 560 may be the public key in the public-key cryptography or the private key in the public-key cryptography. In addition, when the term of the right specified in the right object received from a receiving unit 540 is terminated or when the term of validity set in the DRM agent inputted to the DRM agent operating unit 510 has expired, the control unit 520 deletes the DRM agent stored in the storing unit 530, therefore removing the contents usage right of the second device 240.

The storing unit 530 stores the binding information received from the DRM agent operating unit 510 and the right object received from the receiving unit 540. The binding information may be the public key in the public-key cryptography or the private key in the public-key cryptography and the right object may be coded using the public key in the first device 230.

The receiving unit 540 receives the right object from the first device 230. The received right object may be stored in the storing unit 530.

The contents decoding unit 550 receives the contents decoding key from the DRM agent operating unit 510 and receives the contents from the storing unit 530 so as to decode the coded contents.

The transmission unit 560 receives the binding information from the DRM agent operating unit 510 and transmits the binding information to the first device 230. The binding information may be the public key in the public-key cryptography or the private key in the public-key cryptography.

FIG. 6 is a block diagram illustrating an apparatus for decoding the right object in the DRM system according to an embodiment of the present invention. Referring to FIGS. 2, 5, and 6, the DRM agent includes a binding information obtaining unit 610 and a right object decoding unit 620. The DRM agent may be a computer-readable medium having embodied thereon a computer program for executing the method of decoding the right object. The DRM agent may be formed of codes that can be inputted to the DRM agent operating unit 510.

If the binding information exists in the second device 240, the binding information obtaining unit 610 obtains the binding information. However, if the binding information does not exist in the second device 240, the binding information obtaining unit 610 generates the binding information from the resources of the second device 240. The binding information is outputted to the transmission unit 560 and is transmitted to the first device 230, according to a control by the control unit 520. Then, the binding information is outputted and stored in the storing unit 530. The binding information outputted to the transmission unit 560 may be the public key in the public-key cryptography and the binding information outputted to the storing unit 530 may be the private key in the public-key cryptography.

The right object decoding unit 620 receives and interprets the right object stored in the storing unit 530. In particular, when the received right object is coded by the public key in the public-key cryptography in the first device 230, the received right object is decoded using the private key stored in the storing unit 530. The key to decode the contents (contents decoding key) extracted as a result of the decoding of the received right object is outputted to the contents decoding unit 550.

The DRM agent is stored in the storing unit 530 of the second device 240. If the DRM agent is deleted by a user, the term of the right specified in the right object is terminated. Furthermore, if the term of validity set in the DRM agent expires, the DRM agent may be automatically deleted. In addition, the DRM agent may be copied again to share the contents with a third device.

FIG. 7 is a flow chart illustrating a method of sharing contents in the DRM system according to an embodiment of the present invention. The method of sharing contents in the DRM system will be described with reference to FIGS. 2, 5, and 6.

First, the binding information obtaining unit 610 determines whether the binding information can be obtained from the second device 240 in operation 710. The binding information may be the public key in the public-key cryptography, and the private key in the public-key cryptography.

If the binding information cannot be obtained from the second device 240 (operation 710), the binding information obtaining unit 610 generates new binding information from the resources of the second device 240 in operation 720.

However, if the binding information can be obtained from the second device 240 (operation 710), the binding information obtaining unit 610 obtains the binding information from the second device 240 in operation 730.

Then, the receiving unit 540 receives the right object from the first device 230 in operation 740. The right object may be coded, for example, with the public key in the public-key cryptography in the first device 230.

The right object decoding unit 620 decodes the received right object and extracts the contents decoding key that decodes the contents from the right object in operation 750. The right object may be coded by the public key in the public-key cryptography in the first device 230 and the coded right object may be decoded by the private key stored in the storing unit 530. However, it is understood that other methods may be used to encode, in the first device 230, and decode, in the second device 240, the right object.

The coded contents received by the second device 240 may be provided from the first device 230 through, for example, a short-distance communication channel or mobile media and may also be provided from the contents provider 210 or the third device. Furthermore, the right object and/or the contents decoding key may be provided from a third device.

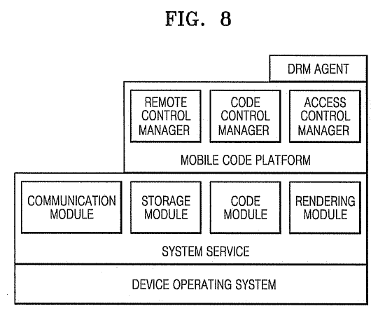

FIG. 8 is a diagram of a layered structure when the apparatus for decoding the right object is provided in a device. The DRM agent is mobile software that is based on a mobile code platform. The mobile code platform may include a remote control manager, a code control manager, and an access control manager. Examples of the mobile code platform may be a java platform.

The mobile code platform is based on a system service, and the system service is based on a device operating system. The system service may include a communication module, a storage module, a code module, and a rendering module.

According to aspects of the present invention, in a method of providing compatibility between the DRM systems, a DRM agent is actively transmitted to devices employing a different DRM system. Thus coded contents can be shared even in different DRM systems. In addition, since the DRM agent may be provided at the time that the right object must be interpreted, the DRM agent need not be originally included by a device manufacturer and a development burden can therefore be reduced.

Aspects of the present invention can be written as computer programs and can be implemented in general-use digital computers that execute the programs using a computer-readable recording medium. In addition, data structures used according to aspects of the present invention can be recorded in the computer-readable recording medium through various methods. Examples of the computer-readable recording medium include magnetic storage media (e.g., ROM, floppy disks, hard disks, etc.), optical recording media (e.g., CD-ROMs, or DVDs), and a computer data signal embodied in a carrier wave comprising a compression source code segment comprising the code and an encryption source code segment comprising the code (such as data transmission through the Internet).

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of sharing contents from a Digital Rights Management (DRM) system, the method comprising:
receiving a DRM agent to interpret a right object corresponding to the contents;
operating the received DRM agent to generate a decoding key to decode the right object;
receiving the contents from a predetermined device and receiving the right object;
decoding the right object using the decoding key to extract a contents decoding key to decode the contents; and
decoding the contents received from the predetermined device using the contents decoding key.

2. The method as claimed in claim 1, wherein:
the operating of the received DRM agent comprises operating the DRM agent to generate a coding key to code the right object;
the decoding of the right object comprises transmitting the coding key to the predetermined device; and
the right object is coded by using the transmitted coding key.

3. The method as claimed in claim 2, wherein the coding key is a public key in a public-key cryptography and the decoding key is a private key in the public-key cryptography.

4. The method as claimed in claim 2, wherein the coding key and the decoding key are secret keys in a secret key cryptography.

5. The method as claimed in claim 1, further comprising:
storing the received DRM agent; and
deleting the stored DRM agent when a usage right comprised in the received right object is terminated.

6. A computer readable recording medium encoded with the method of claim 1 implemented by a computer.

7. A method of decoding a right object corresponding to contents in a Digital Rights Management (DRM) system, the method comprising:
generating a coding key and a decoding key to code and to decode the right object, respectively;
transmitting the coding key to a predetermined device;
receiving the right object coded by using the coding key from the predetermined device; and
decoding the received right object by using the decoding key and extracting a contents decoding key from the decoded right object to decode the corresponding contents.

8. The method as claimed in claim 7, wherein the coding key is a public key in a public-key cryptography and the decoding key is a private key in the public-key cryptography.

9. The method as claimed in claim 7, wherein the coding key and the decoding key are secret keys in a secret key cryptography.

10. A computer readable recording medium encoded with the method of claim 7 implemented by a computer.

11. A method of sharing contents with a device, the method comprising:
transmitting a Digital Rights Management (DRM) agent to the device in order for the device to interpret a right object corresponding to the contents;
receiving a coding key generated by the device operating the DRM agent;
coding the right object by using the coding key; and
transmitting the right object and the contents to the device.

12. An apparatus to receive shared contents, the apparatus comprising:
a receiving unit to receive a Digital Rights Management (DRM) agent for interpreting a right object corresponding to the contents, to receive the contents from a predetermined device, and to receive the right object;
a DRM agent operating unit to generate a decoding key to decode the right object by operating the received DRM agent, to decode the right object by using the decoding key, and to extract a contents decoding key for decoding the contents; and
a contents decoding unit to decode the contents received from the predetermined device by using the contents decoding key.

13. The apparatus as claimed in claim 12, further comprising:
a transmission unit to transmit a coding key to the predetermined device,
wherein the DRM agent operating unit generates the coding key and the right object is coded by using the transmitted coding key.

14. The apparatus as claimed in claim 13, wherein the coding key is a public key in a public-key cryptography and the decoding key is a private key in the public-key cryptography.

15. The apparatus as claimed in claim 13, wherein the coding key and the decoding key are secret keys in a secret key cryptography.

16. The apparatus as claimed in claim 12, further comprising:
a storing unit to store the DRM agent; and
a control unit to delete the stored DRM agent when a usage right comprised in the received right object is terminated.

17. An apparatus for decoding a right object corresponding to shared contents, the apparatus comprising:
a binding information obtaining unit to generate a coding key and a decoding key to code and to decode the right object, respectively; and
a right object decoding unit to decode the right object by using the decoding key when the right object coded with the coding key is received from a predetermined device, and to extract a contents decoding key from the decoded right object to decode the contents.

18. The apparatus as claimed in claim 17, wherein the coding key is a public key in a public-key cryptography and the decoding key is a private key in the public-key cryptography.

19. The apparatus as claimed in claim 17, wherein the coding key and the decoding key are secret keys in a secret key cryptography.

20. An apparatus for sharing contents with another device, the apparatus comprising:
a transmission unit to transmit the contents, a right object corresponding to the contents, and a Digital Rights Management (DRM) agent to the other device in order for the other device to interpret the right object; and
a right object coding unit to receive the a coding key generated by the other device operating the DRM agent, and to code the right object by using the coding key.
